(19) United States
(12) Patent Application Publication
(10) Pub. No.: US 2010/0093306 A1
(43) Pub. Date: Apr. 15, 2010

(54) SYSTEM AND METHOD FOR AVAILING INFORMATION RELATING TO A CIRCUMSTANCE

(75) Inventors: Kuen-Yih Hwang, Naperville, IL (US); Shreenidhi Bharadwaj, Chicago, IL (US); Michael Arthur Koepke, Geneva, IL (US); Jennifer Ann Pierce, Algonquin, IL (US)

Correspondence Address: MICHELLE A. ZARINELLI;C/O WEST CORPORATION, 11808 MIRACLE HILLS DR., MAIL STOP: W11-LEGAL, OMAHA, NE, 68154, US

(73) Assignee: WEST CORPORATION, Omaha, NE (US)

(21) Appl. No.: 12/248,301

(22) Filed: Oct. 9, 2008

(51) Int. Cl. H04M 11/04; H04W 4/00

(52) U.S. Cl. 455/404.2; 455/404.1; 455/466

(57) ABSTRACT

A system for effecting wireless emergency service communication using text messaging includes: (a) at least one network configured for treating received text messaging; each respective network identifying emergency service text communications among the received text messaging; (b) at least one request distributing unit coupled with the at least one network for receiving the emergency service text communications; and (c) at least one emergency service network coupled with the at least one request distributing unit. Each received emergency service text communication is evaluated by at least one of a network and a request distributing unit to ascertain a communication originating locus relating to each received emergency service text communication. Each received emergency service text communication is distributed within the at least one emergency service network by at least one request distributing unit according to the respective communication originating locus.

### FIELD OF THE INVENTION

The present invention is directed to telecommunication systems, and especially emergency service communication systems configured for employing text messaging.

### BACKGROUND OF THE INVENTION

Emergency service communication systems configured for employing text messaging provide a two-way messaging system between a Mobile Station (MS) and a Public Safety Answering Point (PSAP; sometimes referred to as a Public Safety Answering Position) that can be used for placing an emergency service call. Such a system may be briefly referred to as a Messaging 911 (M911) system. Different countries may have different emergency service abbreviated dialing provisions; in the United States, by way of example and not by way of limitation, an emergency service abbreviated dialing sequence is “9-1-1”. In some situations, such as when an armed shooter is in the vicinity, dialing 9-1-1 and talking to a call taker (e.g., a PSAP operator) may be extremely risky for a victim or other caller. In such a situation, talking would likely agitate the shooter and exacerbate an already bad situation. A 9-1-1 text messaging service would be useful in such a situation because emergency personnel could be notified via a text message without a victim or other caller having to talk to a call taker. A victim could quietly text location and other information during a tragedy and a PSAP could notify the police and other emergency service personnel to respond to the incident.

An exemplary M911 service scenario may develop as follows: A subscriber (the request initiator) sends a text message emergency service request. The text message may be presented using Short Message Services (SMS, Multimedia Messaging Service (MMS), Unstructured Supplementary Service Data (USSD) or another messaging format. The text message may be sent using a mobile station (MS); an MS may include, by way of example and not by way of limitation, a cellular telephone, a smart phone, a Personal Digital Assistant (PDA), a networked laptop computer or another originating station. An MS may be deployed in an Unlicensed Mobile Access Network (UMAN) that may be embodied in, by way of example and not by way of limitation, a Wi-Fi network, a Bluetooth network or may employ another type of Unlicensed Mobile Access (UMA). An MS may be deployed in a Radio Access Network (RAN) that may be embodied in, by way of example and not by way of limitation, a cellular network or a Personal Communication System (PCS) network employing any of several communication protocols including, by way of further example and not by way of limitation, Advanced Mobile Phone Service (AMPS), Group Speciale Mobile or Global System for Mobile communications (GSM) or another protocol using Time Division Multiple Access (TDMA); Code Division Multiple Access (CDMA) or another coding scheme.

The text message is addressed or sent to a short code such as, by way of example and not by way of limitation, “91911” to identify the text message as an emergency service short message. Alternatively, the familiar emergency code “911” may be employed for short emergency short messages if desired. The text message may use a recognized format, such as by way of example and not by way of limitation, Short Message Service (SMS), Multimedia Messaging Service (MMS) or Unstructured Supplementary Service Data (USSD), and the body of the message may or may not contain additional information.

The wireless network receiving the text message routes the text message to an Emergency Short Message Service Center (ESMSC). The ESMSC may be embodied in a proprietary service center or may be a publicly owned service center. The ESMSC routes the text message to the correct PSAP data terminal (the request handler), based upon the location of the MS from which the emergency service request call originated (i.e., the originating MS). The text message could be offered to multiple data terminals and only one request handler would respond. The PSAP may respond to the originating MS via a return text message routed back to the originating MS.

There are significant system issues involved in designing a viable M911 system.

A first design issue for a viable M911 system is Short Message Service (SMS) delay. SMS in a wireless network is based on “stored and forwarded” concept. This concept is employed in many UMAN and RAN wireless environments. The incoming short message (SM) is not necessarily delivered to destination party in real time. As indicated by the term “stored and forwarded” the SM is first stored in a Short Message Service Center (SMSC) and is delivered to the destination party once the destination party becomes available. Delay may be on the order of minutes, hours or even days. Such delay present in currently deployed SMS networks may be a problem when dealing with an emergency short message. Real time delivery is an important design criterion for an M911 system. The delay addressed here is related with delay introduced by traditional prior art telecommunication networks, such as GSM networks or CDMA networks. There may be other delays, such as a delay between an ESMSC and a PSAP. It is also assumed that the connection between an ESMSC and PSAP is always available

Another design issue for a viable M911 system may occur when there is no SMS Roaming Agreement between a Serving-Network and a Home-Network. When a MS user is roaming outside his Home Network (H-Network) and is operating in another Serving Network (S-Network) originates an emergency short message, the SM will be first sent and stored in a Home SMSC (HSMSC) located within the H-Network if the S-Network and H-Network have an SMS Roaming Agreement. However, if there is no SMS Roaming Agreement between the S-Network and H-Network, the SM goes nowhere. This is true whether the SM is an emergency SM or a non-emergency SM. A result is that no responding party is alerted to the existence of the emergency prompting sending of the emergency SM and no response is provided to the SM. This issue may arise more often when the MS is roaming from an international H-Network.

Yet another design issue for a viable M911 system may occur when there is no Emergency Short Message Service Agreement between an ESMSC and an H-Network. Even if there is an SMS Roaming Agreement between the S-Network and the H-Network, once an SM reaches an HSMSC in a caller's H-Network, the S-Network loses control of the SM. In such a case, the S-Network may not be able to coordinate with an ESMSC to provide M911 emergency short message service for the MS now located in the HSMSC. The S-Network must rely on the H-Network to communicate with the ESMSC. If there is no Emergency Short Message Service Agreement between an ESMSC and an H-Network, the H-Network cannot deliver the SM to the ESMSC. This issue may arise more often when the MS is roaming from an international H-Network.

Still another design issue for a viable M911 system may occur when the HSMSC does not know which emergency short code belongs to which country. By way of example and not by way of limitation, abbreviated dialing codes (sometimes referred to as short codes, or emergency short codes) 911, 110, 119, 112 and other codes are used by various countries to identify emergency communications. Even if there is an Emergency Short Message Service Agreement between the ESMSC and the HSMSC, if an emergency short code is used by the country in which the S-Network operates, the HSMSC may not be able to identify that an incoming emergency SM should be routed to an ESMSC in the country in which the S-Network operates.

Another design issue for a viable M911 system may occur when the HSMSC does not know to which ESMSC an emergency short message should be routed. Even if an HSMSC is able to identify that an incoming emergency short message should be route to a particular country, the HSMSC may not to which ESMSC in the particular country the emergency SM should be routed if more than one ESMSC exists in the particular country. This is especially so if respective ESMSCs are serviced by different service providers. Further, an ESMSC must also have an emergency service agreement with the S-Network. If an emergency service message is sent to an ESMSC which does not have an emergency service agreement with the S-Network, the ESMSC cannot establish communication with the calling MS to provide the requested emergency service.

Another design issue for a viable M911 system may occur when a mobile station is a SIMless MS. A SIM (Subscriber Identity Module) is a “smart” card installed or inserted into a mobile station that can contain all subscriber-related data. As a result, a phone not having a SIM (herein referred to as a SIMless MS) does not have an H-Network or an HSMSC to which an emergency short message may be sent. As a result, current network architectures to not support emergency short messages originating from a SIMless MS.

Still another design issue for a viable M911 system may occur when a MS may not have sufficient account balance to originate a SM. If a bill associated with a MS is not paid or if an associated account balance is too low to originate a SM, the MS may have problem originating an emergency short message. A viable M911 system should permit an arrears MS with insufficient account balance to originate an emergency short message even if the arrears MS may not be permitted to originate a non-emergency short message.

Another design issue for a viable M911 system may occur when a MS is prohibited from originating a SM for any reason, such as being listed on a black list or for another reason. There is a need to clearly distinguish an SM as an emergency short message rather than a non-emergency short message. Such distinction would preferably be effected by the S-Network as early as possible in the message flow. Each type of SM should be treated differently. Under emergency situations, the S-Network should permit any and all MS to originate an emergency short message; even such MS may be prohibited from originating a non-emergency SM for any reason. Traditional prior art SMS networks do not distinguish between emergency SM and non-emergency SM clearly or at a sufficiently early stage of message flow.

There is a need for a messaging 911 system and a method for operating a messaging 911 system that overcomes the above-described design issues.

### SUMMARY OF THE INVENTION

A system for effecting wireless emergency service communication using text messaging includes: (a) at least one network configured for treating received text messaging; each respective network identifying emergency service text communications among the received text messaging; (b) at least one request distributing unit coupled with the at least one network for receiving the emergency service text communications; and (c) at least one emergency service network coupled with the at least one request distributing unit. Each received emergency service text communication is evaluated by at least one of a network and a request distributing unit to ascertain a communication originating locus relating to each received emergency service text communication. Each received emergency service text communication is distributed within the at least one emergency service network by at least one request distributing unit according to the respective communication originating locus.

A method for effecting wireless emergency service communication using text messaging includes: (a) in no particular order: (1) providing at least one network configured for treating received the text messaging; (2) providing at least one request distributing unit coupled with the at least one network for receiving the emergency service text communications; and (3) providing at least one emergency service network coupled with the at least one request distributing unit; (b) operating each respective network of the at least one network to effect identifying emergency service text communications among the received text messaging; (c) evaluating each respective received emergency service text communication by at least one of the at least one network and the at least one request distributing unit to effect ascertaining a respective communication originating locus relating to each the respective received emergency service test communication; and (d) distributing each respective received emergency service text communication within the at least one emergency service network by at least one respective request distributing unit of the at least one request distributing unit according to the respective communication originating locus.

It is, therefore, a feature of the present invention to provide a messaging 911 system and a method for operating a messaging 911 system that overcomes the above-described design issues.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic illustration of a system for effecting the present invention.

FIG. 2 is a schematic diagram illustrating a call flow for a Short Message System (SMS) communication when the user enters the location.

FIG. 3 is a schematic diagram illustrating call flow for a Short Message System (SMS) communication when a communication originator does not respond to a request for location information.

FIG. 4 is a schematic diagram illustrating call flow for a Short Message System (SMS) communication when a communication originator responds to a request for location information with an invalid location indication.

FIG. 5 is a schematic diagram illustrating normal call flow for a Multimedia Message System (MMS) communication.

FIG. 6 is a schematic illustration of a system for effecting the present invention in a GSM architecture.

FIG. 7 is a schematic diagram illustrating normal call flow for SMS communications originating from a mobile unit in a GSM architecture.

FIG. 8 is a schematic diagram illustrating normal call flow for SMS communications terminating with a mobile unit in a GSM architecture.

FIG. 9 is a schematic diagram illustrating call flow for a Messaging 911 (M911) communication in a GSM architecture.

FIG. 10 is a schematic diagram illustrating call flow for a Messaging 911 (M911) communication in a GSM architecture using Short Message Peer-to-Peer (SMPP) Protocol.

FIG. 11 is a schematic diagram illustrating call flow for determining the mobile's location information in a Messaging 911 (M911) system in a GSM architecture.

FIG. 12 is a schematic diagram illustrating call flow for a Messaging 911 (M911) communication in a CDMA architecture.

FIG. 13 is a schematic diagram illustrating call flow for a Messaging 911 (M911) communication in a CDMA architecture for effecting a momentary inquiry to retrieve serving cell identification.

FIG. 14 is a schematic diagram illustrating call flow for a Messaging 911 (M911) communication for effecting an inquiry to retrieve location information.

FIG. 15 is a schematic diagram illustrating call flow for M911 communications terminating with a mobile unit in a CDMA architecture.

FIG. 16 is a schematic diagram illustrating call flow relating to selection of a particular call handler at a PSAP.

FIG. 17 is a schematic diagram illustrating call flow relating to transferring an M911 call from a first PSAP to a second PSAP.

FIG. 18 is a schematic diagram illustrating call flow relating to effecting a consultive transfer of an M911 call from a first PSAP to a second PSAP.

FIG. 19 is a schematic diagram illustrating call flow relating to effecting a joining in an ongoing M911 call session by a PSAP operator.

FIG. 20 is a schematic diagram illustrating call flow for a Messaging 911 (M911) communication directly from a Serving MSC to a M911 Network Element.

FIG. 21 is a schematic diagram illustrating call flow for an outgoing Emergency Short Message from a PSAP to a Mobile Station.

FIG. 22 is a flow chart illustrating the method of the present invention.

### DETAILED DESCRIPTION

For purposes of illustration, by way of example and not by way of limitation, the present invention will be discussed in the context of an emergency service network in the United States, commonly referred to as an E9-1-1 network. The teachings of the present invention are equally applicable, useful and novel in other special number calling systems, such as maintenance service networks, college campus security networks and other networks.

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

When the terms “coupled” and “connected”, along with their derivatives, are used herein, it should be understood that these terms are not intended as synonyms for each other. Rather, in particular embodiments, “connected” is used to indicate that two or more elements are in direct physical or electrical contact with each other. “Coupled” is used to indicated that two or more elements are in either direct or indirect (with other intervening elements between them) physical or electrical contact with each other, or that the two or more elements co-operate or interact with each other (e.g., as in a cause-and-effect relationship).

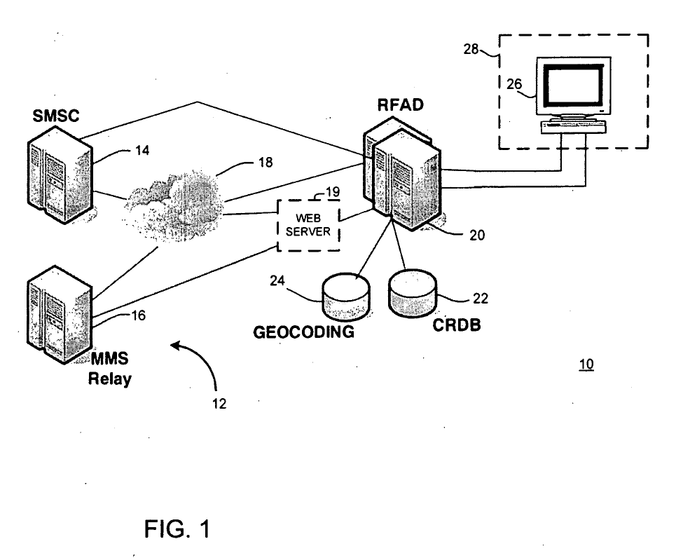

FIG. 1 is a schematic illustration of a system for effecting the present invention. In FIG. 1, an exemplary M911 system 10 includes a network 12 configured for treating text messaging. Network 12 may include a Short Message Service Center (SMSC) 14 for handling received text messages composed using a Short Message Service (SMS) protocol or format. Network 12 may also include a Multimedia Messaging System (MMS) relay unit 16 for handling received text messages composed using a MMS protocol or format. Network 12 may also include a network such as an Internet Protocol (IP) network 18 for effecting communications with SMSC 14 and MMS relay unit 16.

System 10 also includes a Request for Assistance Distributor (RFAD) 20. RFAD 20 may be embodied in an Emergency Short Message Service Center (ESMSC) or another request distributing unit configured for operation using SMS protocol text messages, MMS protocol text messages or other protocol text messages. A web server 19 may be employed with RFAD 20 to treat MMS messages. Web server 19 is indicated in FIG. 1 to represent that web server 19 may be incorporated as a part of RFAD 20 rather than being provided as a separate unit. RFAD 20 is coupled with a Coordinate Routing Data Base (CRDB) 22 and a geocoding unit 24. RFAD 20 is also coupled with one or more PSAP operator's station, represented in FIG. 1 by a PSAP operator's station 26 in a PSAP 28. PSAP operator's station 26 may also be referred to as an Emergency Communication Response Center or Console (ECRC) 26. SMSC 14 and MMS relay unit 16 may be coupled directly with RFAD 20. CRDB 22 and geocoding unit 24 may each be embodied in a plurality of units (not shown in detail in FIG. 1; understood by those skilled in the art of emergency services network design).

System 10 is preferably configured as a carrier agnostic system in which SMS and MMS messages may be directed using an prearranged emergency text message address code or short code such as, by way of example and not by way of limitation, the short code “91911”. Short code 91911 may forward text messages within system 10 to RFAD 20 with a coarse location included in the body of the message. RFAD 20 may be embodied in a proprietary request distributing unit accessed by a proprietary network routing (not shown in detail in FIG. 1; understood by those skilled in the art of emergency services network design). If the text message (e.g., a SMS or MMS message) does not include location information, RFAD 20 may communicate with the sender of the text message to request that the sender insert location information in a new text message and send the new text message using with the same short code 91911. When RFAD 20 receives the new text message with location information included, RFAD 20 parses the body of the new text message, extracts out the location information (e.g. “IL” for the State of Illinois, “Chicago” for the City). RFAD 20 may then communicate with geocoding unit 24 to effect geocoding of the location information in an X-Y expression. The geocoded location expression may be used by RFAD 20 to query CRDB 22 to determine an appropriate PSAP 28 to which the new text message should be routed so as to efficiently respond to the emergency request conveyed by the new text message. Once PSAP 28 is determined, an SMS notification message is sent to ECRC 26 to alert a request handler at ECRC 26. The request handler may then accept the new text message and manage the related emergency event.

When an emergency text message is conveyed using MMS format or protocol, there is an additional step for processing MMS text messages. When RFAD 20 receives a MMS message, RFAD 20 caches the content section of the message body which may include text and graphics. RFAD 20 then looks for the location information embedded in the message body and processes the message as described above in connection with a SMS text message. The message sent to PSAP 28 includes a Universal Resource Identifier (URI) which may be used to retrieve the MMS attachment.

For SMS text messages, SMSC 14 routes the short code 91911 through IP Network 18 to RFAD 20. In addition a wireless carrier may connect via IP directly to RFAD 20. Connectivity between the IP Network 18 and RFAD 20 may be established using the Short Message Peer-to-Peer (SMPP) protocol, which forwards the SMS text message to RFAD 20.

Connection for MMS text messages may be established between network 18 and RFAD 20 using MM7 protocol if RFAD 20 is connected to an intermediary MMS service provider. Direct connection between MMS relay unit 16 and RFAD 20 may be established using MM4 protocol. RFAD 20 extracts location information from the message body of the received text message and uses the location information to determine the appropriate PSAP 28 to which the received text message should be routed. Connectivity to PSAP 28 may be through standard protocols such as, by way of example and not by way of limitation, Session Initiation Protocol (SIP) or eXtensible Markup Language (XML) to deliver the message to PSAP 28. For MMS messages an additional data connection is required at PSAP 28 to retrieve multimedia attachments. This MMS interface may use Emergency Services Messaging Interface (ESMI), Emergency Information Services Interface (EISI) or generic web services.

RFAD 20 is a SMS and MMS message distributor that acts as a proxy server between SMSC 14 and PSAP 28. RFAD 20 communicates with SMSC 14 and MMS relay unit 16 to distribute messages to PSAP 28 and receive responses that may be returned to the request initiator who originated the text message. It may serve multiple PSAPs 28 depending upon geography, capacity or other considerations. For each PSAP 28, ECRCs 26 register with RFAD 20, identifying their association with a respective PSAP 28. This registration is not role based and RFAD 20 assumes that all stations are capable of receiving messages. The registration mechanism may follow a typical “login” or other such well know mechanism. RFAD 20 will use this “presence” information obtained during the login process to distribute requests to appropriate stations (e.g., PSAP 28).

RFAD 20 correlates messages between a specific request initiator and an assigned PSAP 28. This correlation emulates a “session” between the request initiator and the assigned PSAP 28. RFAD 20 creates a session with the initially received SMS message and manages sessions and associates SMS messages to the proper session. RFAD 20 keeps track of the state and status of all sessions and associated SMS messages. The request handler at PSAP 28 may terminate a session when it is determined that the request-response interaction is complete.

When RFAD 20 receives a message from SMSC 14 or MMS relay unit 16 RFAD 20 must determine whether the extant message is the first message in a session or the extant message is a message within an existing session. If the extant message is the first message in a session, RFAD 20 will check if the location information is contained within the message body. If no location is contained within the message body RFAD 20 will send a message to the request initiator to provide location information. When RFAD 20 receives a message with location information in the message body RFAD 20 will send the location information to geocoder unit 24 to determine an X-Y location expression, such as by way of example and not by way of limitation, a latitude-and-longitude expression. Once RFAD 20 receives a latitude-and-longitude expression RFAD 20 queries CRDB 22 to determine the identification of appropriate PSAPs 28 to receive the message. RFAD 20 then sends a notification to each identified PSAP 28 that a message has arrived (or RFAD 20 could use automatic call distribution logic) and RFAD 20 tracks which request handler (ECRC 26) selects the message. For MMS messages, RFAD 20 has an additional processing step. The incoming MMS message from MMS relay unit contains a two part message body. The MMS message body will be cached in RFAD 20 and a URI will be created as a pointer to the cached message body. The MMS message that is delivered to ECRC 26 will contain this URI and the request handler will need to query a network element (web server) in order to obtain the cached multimedia object.

RFAD 20 manages and updates the screen data display at ECRC 26, including text frames and display queues; through client software on the display unit at ECRC 26.

If the request handler at ECRC 26 sends a return message to the request initiator, RFAD 20 will forward that return message to SMSC 14 or MMS relay unit 16 depending upon the application. SMSC 14 or MMS relay unit 16 will forward the return message through the wireless network coupled with SMSC 14 or MMS relay unit 16 (not shown in FIG. 1; understood by those skilled in the art of emergency services network design). RFAD 20 may also distribute the return messages to other request handlers at other ECRCs 26 that may be joined in the session.

If the request initiator sends additional messages prior to the Request for Assistance (RFA) being terminated by the request handler at ECRC 26, RFAD 20 will correlate those additional messages with an existing session and forward the additional message to the appropriate ECRC 26. RFAD 20 will also maintain a history of the text message thread, including text data and identification of origination.

Another user may join this session at any time. This joined user will be able to obtain the history of the existing session as well as subsequent messages exchanged during the session.

Message sessions may be transferred between request handlers at PSAPs 28. RFAD 20 notifies the software associated with request handler's Data Display at the appropriate ECRC 26 advising of the valid list of “transfer to” PSAPs based upon the RFA.

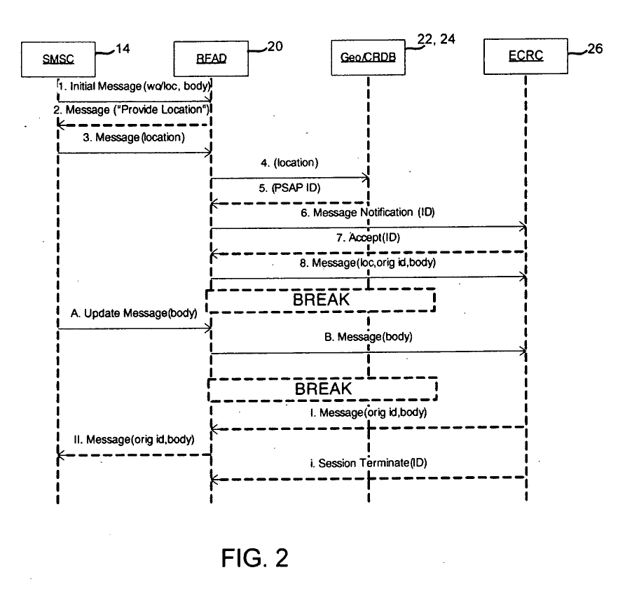

FIG. 2 is a schematic diagram illustrating a call flow for a Short Message System (SMS) communication when the user enters the location. In FIG. 2, call flows are represented among (referring to components described in connection with FIG. 1) SMSC 14, RFAD 20, CRDB 22, Geocoding unit 24 and ECRC 26. CRDB 22 and Geocoding unit 24 are treated as a single station in call flows described in FIG. 2.

Call flows in FIG. 2 represent network aspects of call routing on City/State location information in the body of an SMS message. The call flows include normal call flow, timeout waiting for the request initiator to respond with location information and an invalid location provided by the request initiator. Normal call flow is illustrated delivering the message to RFAD 20 and the request initiator is asked to provide location information regarding their communication originating locus. When a message comes containing location information, the location information is geocoded and an appropriate PSAP 28 for responding to the Request for Assistance (RFA) is identified. The extant message is then delivered to the appropriate ECRC 26. Note: in the following flows some Acknowledgements (ACKs) may have been omitted as will be understood by those skilled in the art of emergency services network design.

FIG. 2 illustrates call flow as follows:
1. The request initiator sends an SMS message with short code 91911 and the message is forwarded to RFAD 20.
2. RFAD 20 checks to see whether a current session exists for the extant request. In the exemplary call flow of FIG. 2, a current session does not exist for the extant request, so RFAD 20 checks to see whether location information is included in the body of the message. In the exemplary call flow of FIG. 2, location information is not included in the body of the message, so RFAD 20 initiates a request to the request initiator through SMSC 14 to provide location information.
3. The request initiator sends a second SMS message with location information included and the second message is forwarded to RFAD 20.
4. RFAD 20 forwards the location information to geocoder unit 24 and geocoder unit 24 determines an X-Y expression of the location information. Then RFAD 20 forwards the X-Y expression to CRDB 22 to identify an appropriate PSAP 24 (PSAP ID) for responding to the RFA in the extant message. (Note flows are combined for simplification)
5. The PSAP ID is returned.
6. RFAD 20 correlates the PSAP ID with a set of ECRCs 26. It sends a notification to each ECRC 26 that an SMS message has arrived.
7. One of the request handlers at a particular ECRC 26 accepts the request
8. RFAD 20 forwards the message to ECRC 26 with location information, originator identification (e.g. Mobile Station Integrated Services Digital Network (MSISDN)) and the body of the extant message.

At some point the request initiator may send an additional message with some information.
A. The request initiator sends a message with additional information. The message is forwarded to RFAD 20.
B. Since RFAD 20 has an open session RFAD 20 knows to which request handler (ECRC 26) to forward the request and sends the message to that request handler.

The request handler may send a message to the request initiator.
I. The request handler ECRC 26 initiates a message toward the request initiator.
II. RFAD 20 converts the protocols and forwards the message to SMSC 14 and the message is delivered to the request initiator
   At some point the request initiator (ECRC 26) recognizes that the session is over and terminates the session (i.)

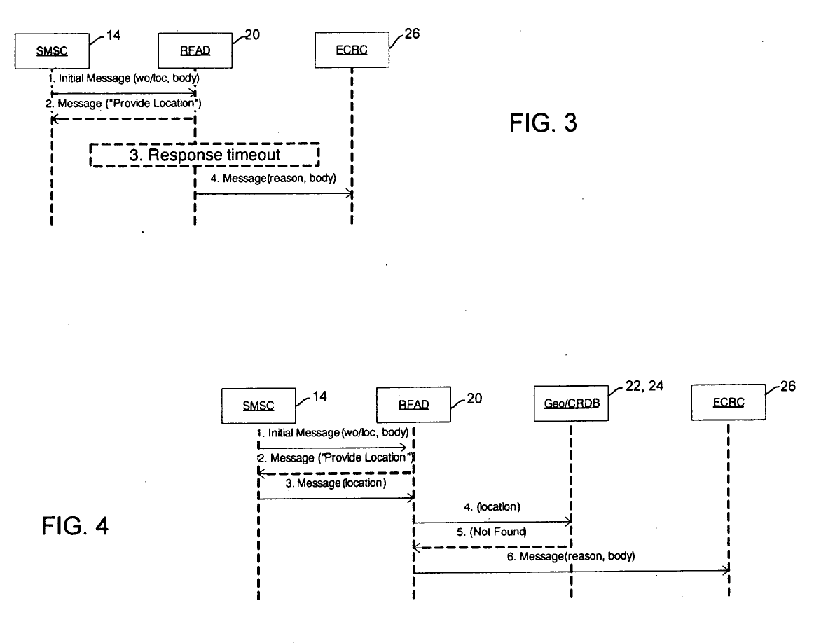

FIG. 3 is a schematic diagram illustrating call flow for a Short Message System (SMS) communication when a communication originator does not respond to a request for location information. In FIG. 3, call flows are represented among (referring to components described in connection with FIG. 1) SMSC 14, RFAD 20 and ECRC 26.

FIG. 3 illustrates a call flow in which a request initiator does not respond to the request to provide location information:
1. The request initiator sends an SMS message with short code 91911 and the message is forwarded to RFAD 20.
2. RFAD 20 checks whether a current session exists for this extant request. No current session exists for this extant request, so RFAD 20 checks whether location information is included in the body of the message. Location information is not included in the body of the message, so RFAD 20 initiates a request to the request initiator through SMSC 14 to provide location information.
3. The response from the request initiator times out. That is, no reply is received from the request initiator within a predetermined time interval.
4. RFAD 20 forwards the message to ECRC 26.

FIG. 4 is a schematic diagram illustrating call flow for a Short Message System (SMS) communication when a communication originator responds to a request for location information with an invalid location indication. In FIG. 4, call flows are represented among (referring to components described in connection with FIG. 1) SMSC 14, RFAD 20, CRDB 22, Geocoding unit 24 and ECRC 26. CRDB 22 and Geocoding unit 24 are treated as a single station in call flows described in FIG. 4.

FIG. 4 illustrates a call flow in which the location or communication originating locus cannot be geocoded or an X-Y expression for the location is not available in CRDB 22.
1. The request initiator sends an SMS message with short code 91911 and the message is forwarded to RFAD 20.
2. RFAD 20 checks whether a current session exists for this extant request. No current session exists for this extant request, so RFAD 20 checks whether location information is included in the body of the message. No location information is included in the body of the message, so RFAD 20 initiates a request to the request initiator through SMSC 14 to provide location information.
3. The request initiator sends a second SMS message with location information and the second message is forwarded to RFAD 20.
4. RFAD 20 forwards the location information to geocoder unit 24 and geocoder unit 24 determines an X-Y location expression. Then RFAD 20 forwards the X-Y location expression to CRDB 22 to identify an appropriate PSAP 28 with ECRC 26 (i.e., to obtain a PSAP ID). In this exemplary call flow the location information received from the request initiator either cannot be geocoded or the location is not available in CRDB 22.
5. An error response is returned to RFAD 20 from either geocoder unit 24 or CRDB 22.

RFAD 20 forwards the message to ECRC 26.

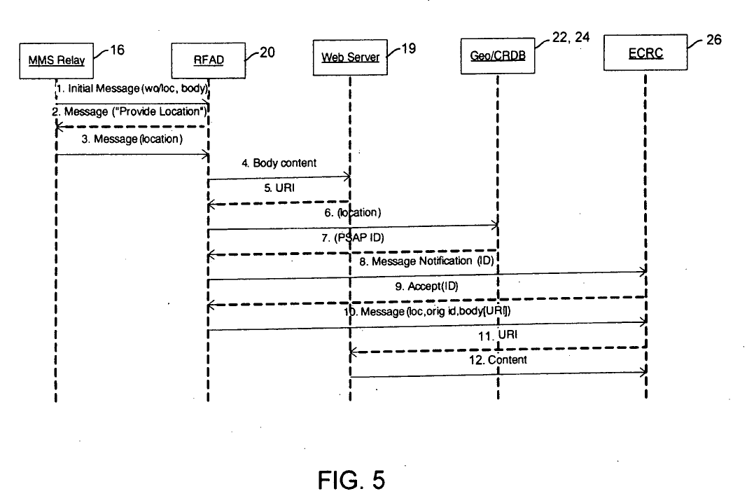

FIG. 5 is a schematic diagram illustrating normal call flow for a Multimedia Message System (MMS) communication. In FIG. 5, call flows are represented among (referring to components described in connection with FIG. 1) MMS relay unit 16, RFAD 20, web server 19, CRDB 22, Geocoding unit 24 and ECRC 26. CRDB 22 and Geocoding unit 24 are treated as a single station in call flows described in FIG. 5.

Call flows in FIG. 5 represent MMS call flows. MMS call flows are similar to SMS call flows except for the need to cache the multimedia attachment associated with MMS calls and to require PSAP 28 to initiate a query to obtain the multimedia attachment. Only a normal MMS call flow is illustrated in FIG. 5. Other call flows can be extrapolated by those skilled in the art of emergency communication system designs from related SMS call flows.

For a normal call flow an MMS message is received by RFAD 20 and RFAD 20 determines whether location information is in the body of the message. If location information is not in the body of the message, RFAD 20 requests location information from the request initiator. When the location information is supplied, RFAD 20 caches the message body (text and multimedia content) in Web Server 19. Keep in mind that Web Server 19 is not necessarily a separate host from RFAD 20. The call flow then substantially follows call flow of SMS messages, except that the URI pointing to the message body in Web Server 19 is sent in the message to PSAP 26. PSAP 26 must query web server 19 to obtain the message body. Call flow represented in FIG. 5 proceeds as follows:
1. The request initiator sends an MMS message using short code 91911 and the message is forwarded to RFAD 20. The message body is assumed to contain text, including location information and a description of the emergency, and contain a multimedia body.
2. RFAD 20 checks whether a current session exists for this extant request. A current session does not exist for this extant request, so RFAD 20 checks whether location information is included in the message body. Location information is not included in the message body, so RFAD 20 initiates a request to the request initiator through MMS relay unit 16 to provide location information.
3. The request initiator sends a second MMS message with location information in the text portion of the message body and the second message is forwarded to RFAD 20.
4. RFAD 20 caches the content of the message which is assumed to have a text and multimedia component. (Note that it is assumed that the multimedia attachment came in step 1. The multimedia attachment could have been cached when first received.)
5. Web Server 19 (not necessarily a separate host from RFAD 20) returns a URI that is a pointer to the multimedia content.
6. RFAD 20 forwards the location information to geocoder unit 24 and geocoder unit 24 determines an X-Y expression of the location information. Then RFAD 20 forwards the X-Y expression of the location information to CRDB 22 to obtain an appropriate PSAP 28 with ECRC 26 (i.e., to obtain a PSAP ID). (Note: Flows are combined for simplification).
7. The PSAP ID is returned to RFAD 20.
8. RFAD 20 correlates the PSAP ID with a set of ECRCs 26. RFAD 20 sends a notification to each ECRC 26 that an MMS message has arrived.
9. One of the request handlers at an ECRC 26 accepts the request.
10. RFAD 20 forwards the message to the accepting ECRC 26 with location information, originator ID (e.g. MSISDN) and message body that contains the URI.
11. PSAP queries Web Server 19 using the URI pointer.
12. Web Server 19 returns the multimedia content to ECRC 26.

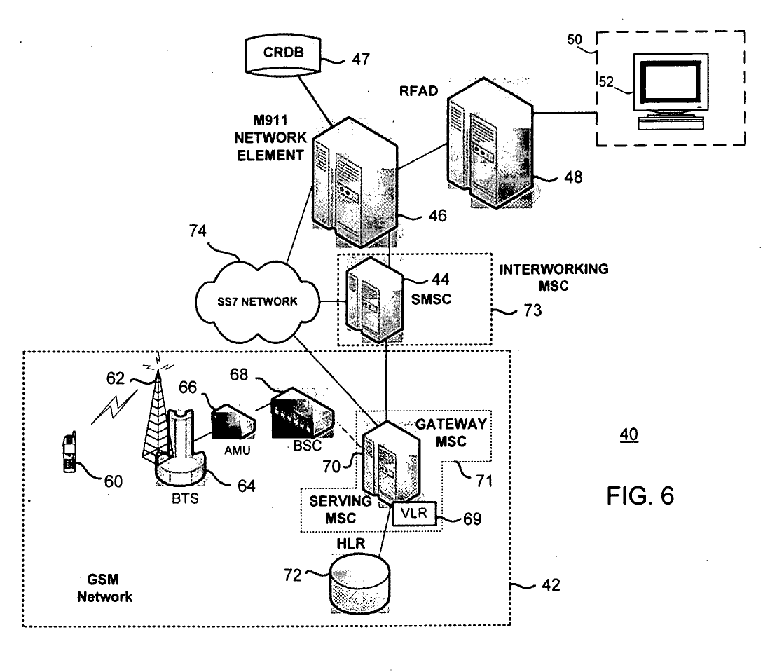

FIG. 6 is a schematic illustration of a system for effecting the present invention in a GSM architecture. In FIG. 6, a GSM-compatible M911 system 40 includes a GSM Network 42, a short message service center 44, a M911 Network Element 46, a Request for Assistance Distributor (RFAD) 48 and a PSAP 50. PSAP 50 includes at least one Emergency Communication Response Center or Console (ECRC) 52.

GSM network 42 includes a Mobile Station (MS) 60 in wireless communication with a communication tower 62 coupled with a Base Transceiver Station (BTS) 64. BTS 64 is coupled with a Serving Mobile Switching Center (Serving MSC) 70 via an Abis Monitoring Unit (AMU) 66 and a Base Station Controller (BSC) 68. MSC 70 includes a Visitors' Location Register (VLR) 69 and is coupled with a Home Location Register (HLR) 72. Serving MSC 70 is coupled with M911 Network Element 46 via a SS7 Network 74 (or may employ a different protocol), via SMSC 44 or via SMSC 44 and SS7 Network 74. M911 Network Element 46 is coupled with a Call Routing Data Base (CRDB) 47. Serving MSC may also operate in the role of a Gateway Mobile Switching Center (Gateway MSC) 71. A Gateway MSC is a Mobile Switching Center (MSC) that determines which MSC is called to reach a particular MS. SMSC 44 typically also performs the function of Interworking MSC 73.

System 40 generally illustrates an architecture necessary to support M911. The architecture illustrated is basically a GSM wireless architecture design for short message service delivery.

Although only one architecture version is provided, FIG. 6 actually illustrates multiple architecture options. The key to the different options is based upon how the short message is delivered from SMSC 44 to M911 Network Element 46. Some of the architecture options include:
Delivering a message from the originator's SMSC 44 through SS7 network 74 to M911 Network Element 46.
Delivering a message from the originator's SMSC 44 through SMPP or some proprietary SMSC protocol to M911 Network Element 46.
Delivering a message, via SS7 Network 74, directly from the originator's Serving MSC 70 to M911 Network Element 46.

MS 60 sends a SMS in an emergency call situation using short code 91911 to indicate that the SMS/MMS is intended for a PSAP. Location information relating to MS 60 is not inserted in the SMS. MS 60 can also receive a SMS from a PSAP.

Location information used to route the short message is based upon Cell/Sector ID information relating to location of communication tower 62 or associated elements BTS 64, AMU 66, BSC 68. BTS 64, AMU 66 and BSC 68 are network elements that deliver the short message from the air interface between MS 60 and communication tower 62 to MSC 70. Standard GSM interfaces are used here for SMS delivery. M911 does not impact these standard GSM interfaces.

For M911, the roles of MSCs 70, 71, 73 depend upon the call flow implemented. Serving MSC 70 may route the short message to tnterworking MSC 73 in SMSC 44, Serving MSC 70 may bypass SMSC 44 and directly route the message to M911Network Element 46 (via SS7 Network 74), or Serving MSC 70 may query M911 Network Element 46 for routing information and route the short message to the correct RFAD 48.

The Visitor Location Register (VLR) is a logical network element concept that is substantially always co-located with Serving MSC 70. The VLR tracks location of MS 60 at a cell/sector level. M911 Network Element 46 queries the VLR to determine the cell/sector where MS 60 is located.

HLR 72 contains the subscriber database for cellular users, as well as the Integrated Services Digital Network (ISDN) address for Serving MS 70 to indicate location of MS 60. This MSC ISDN Address is the address of the MSC where the subscriber is currently located. For basic cellular calls and short message service, HLR 72 tracks which services a subscriber is allowed to use (e.g. if a subscriber can use short message service). HLR 72 also tracks with which MSC a subscriber (i.e., MS 60) is located.

In traditional GSM short message delivery, when SMSC 44 is ready to deliver a message, SMSC 44 delivers the message to Gateway MSC 71. Gateway MSC 71 queries HLR 72 for the Serving MSC 70 where the subscriber is located. This is so the short message can be delivered to SMSC 44.

In the M911 solution, when a message is delivered from MS 60 to PSAP 50, M911 Network Element 46 acts as a HLR from a functional entity standpoint. However, when a short message is delivered from PSAP 50 to MS 60, the traditional GSM HLR 72 is queried.

SMSC 44 receives short messages from MS 60. The purpose of SMSC 44 is to forward the short message. If the message is not successfully delivered to the terminating party (another MS or PSAP 50 in the M911 solution illustrated in FIG. 6), SMSC 44 will retry delivery of the message.

From a high level functionality standpoint, the purpose of M911 Network Element 46 is to:
Determine the location of the MS that originated the short message in order to route the message to the correct RFAD/PSAP data terminal.
Route the short message to the correct RFAD, including the “to” address, the “from” address, and the message body in the short message.
Receive a short message from the RFAD and route it to the SMSC.

In designing GSM compatible M911 system 40 one should determine whether a short message is to be sent to M911 Network Element 46 via SS7 Network 74 from SMSC 44, or via SMPP (or some other protocol) directly from SMSC 44 for the mobile originated case. Likewise, when PSAP 50 sends a short message via RFAD 44 to M911 Network Element 46, it must be determined if SS7 Network 74 or SMPP (or some other protocol) is to be used to get the message to SMSC 44.

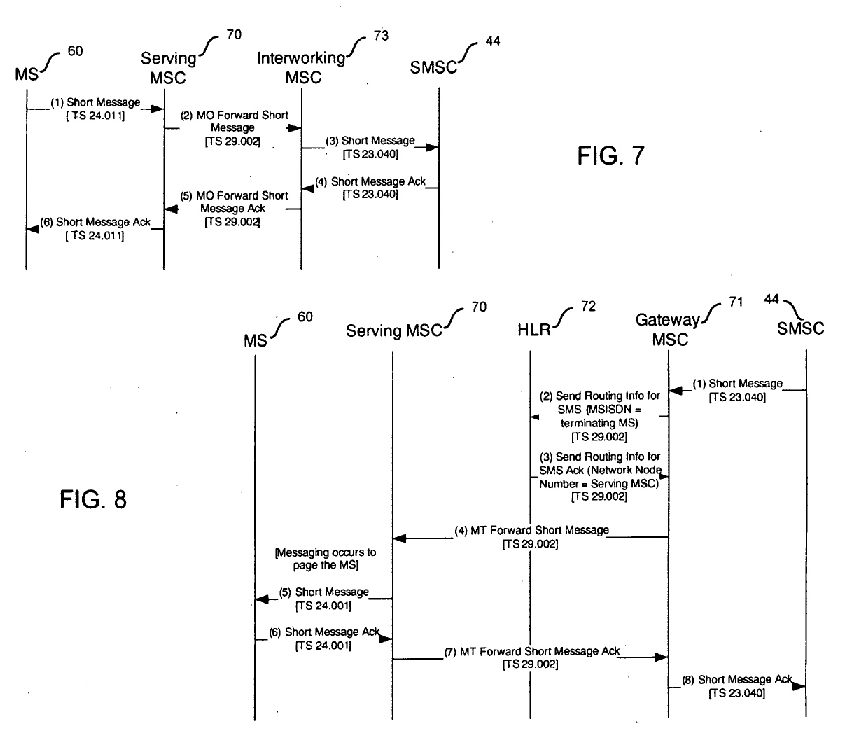

FIG. 7 is a schematic diagram illustrating normal call flow for SMS communications originating from a mobile unit in a GSM architecture. In FIG. 7, call flows are represented among (referring to components described in connection with FIG. 6) Mobile Station (MS) 60, Serving MSC 70, Interworking MSC 73 and SMSC 44.

FIG. 7 illustrates call flow for a Short Message Service (SMS) call in GSM system 40. In GSM systems such as GSM system 40 (FIG. 6), when MS 60 originates a short message, the short message is delivered to Short Message Service Center (SMSC) 44. If it is determined that the recipient of the SMS is a Mobile Station, the basic mobile terminated call flow illustrated in FIG. 8 is executed.

In FIG. 7, MS 60 originates a SMS call. The short message (SM) is sent to SMSC 44:
1. The subscriber (MS 60) sends a SM, specifying the terminating party's MSISDN.

The SM traverses through the air interface between MS 60 and communication tower 62 (not shown in detail in FIG. 7; understood by those skilled in the art of wireless telecommunication system design) and ends up at Serving MSC 70. Serving MSC 70 is the MSC that handles calls where MS 60 is located.
2. Serving MSC 70 converts the SM received into the MAP protocol format [defined by standard TS 29.002]. This MAP-formatted SM is then sent to Interworking MSC 73. Interworking MSC 73 is a MSC that has the ability to communicate with SMSC 44. Serving MSC 70 and Interworking MSC 73 may be co-located. Further, SMSC 44 and Interworking MSC 73 may be co-located, as illustrated in FIG. 6.
3. Interworking MSC 73 converts the message into a format that SMSC 44 understands [defined by standard TS 23.040] and sends the message for delivery or storage to SMSC 44.
4. SMSC 44 sends an Acknowledgement Message (“Ack”) to Interworking MSC 73. The Ack means SMSC 44 has successfully received the message.
5. Interworking MSC 73 acknowledges receipt of the SM to Serving MSC 70.
6. Serving MSC 70 acknowledges receipt of the message to MS 60.

FIG. 8 is a schematic diagram illustrating normal call flow for SMS communications terminating with a mobile unit in a GSM architecture. In FIG. 8, call flows are represented among (referring to components described in connection with FIG. 6) Mobile Station (MS) 60, Serving MSC 70, Home Location Register (HLR) 72, Gateway MSC 71 and SMSC 44.

FIG. 8 illustrates SMS call flow in GSM system 40 (FIG. 6) when the recipient of the SMS is a Mobile Station:
1. SMSC 44 determines that the short message must be delivered, so SMSC 44 sends the short message to Gateway MSC 71. Gateway MSC 71 is a MSC that can query HLR 72 for a subscriber's location.
2. Gateway MSC 71 queries HLR 72 for the terminating MS 60 location. One of the parameters in the Send Routing Information (SRI)-for-SMS message is the terminating party's MSISDN.
3. HLR 72 returns the address of Serving MSC 70 cited in the SRI-for-SMS Ack. This is the MSC that handles the coverage area where MS 60 is located.
4. Gateway MSC 71 forwards the short message to Serving MSC 70.
5. Serving MSC 70 pages MS 60, and then delivers the short message.
6. MS 60 acknowledges the delivery of the short message to Serving MSC 70.
7. Serving MSC 70 acknowledges the delivery of the short message to Gateway MSC 71.
8. Gateway MSC 71 acknowledges delivery of the short message to SMSC 44.

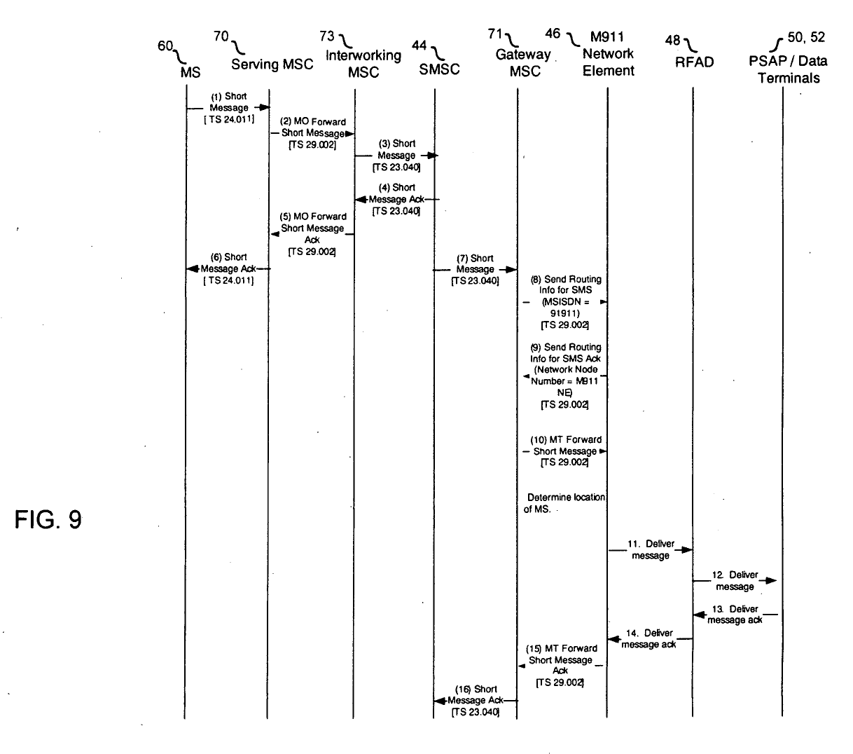

FIG. 9 is a schematic diagram illustrating call flow for a Messaging 911 (M911) communication in a GSM architecture. In FIG. 9, call flows are represented among (referring to components described in connection with FIG. 6) Mobile Station (MS) 60, Serving MSC 70, Interworking MSC 73, SMSC 44, Gateway MSC 71, M911 Network Element 46, RFAD 48, PSAP 50 and PSAP-associated Data Terminals 52.

The GSM M911 solution must be able to route the M911 message to the appropriate PSAP 50, using the existing GSM message flow. In order for the M911 short message to be delivered to the appropriate PSAP 50, M911 Network Element 46 must have the ability to determine the location of the originating subscriber (MS 60), using the originating subscriber's MSISDN. The originator's MSISDN is not known using MAP messages until the short message is forwarded (see call flow step 4; FIG. 9). Thus, a mechanism is needed to assure the Short message is forwarded to M911 Network Element 46. This implies that M911 Network Element 46 must behave as HLR and as a Serving MSC.

The original GSM mobile originated portion of the message flow is modified to support M911 call flow:
1. The subscriber is in an emergency situation and sends a Short Message Service (SMS) Short Message (SM) with the short code “91911”. The message traverses the air interface between MS 60 and communication tower 62 (FIG. 6; not shown in detail in FIG. 9; understood by those skilled in the art of wireless communications) and ends up at Serving MSC 70.
2. Serving MSC 70 converts the short message received into the MAP protocol format [TS 29.002]. This MAP-formatted message is then sent to Interworking MSC 73.
3. Interworking MSC 73 converts the MAP-formatted message into a format SMSC 44 understands [TS 23.040] and sends the message for delivery or storage (or delivery and storage) to SMSC 44.
4. SMSC 44 sends an Acknowledgement Message “Ack” to Interworking MSC 63. The Ack means SMSC 44 has successfully received the message.
5. Interworking MSC 73 acknowledges receipt of the short message to Serving MSC 70.
6. Serving MSC 70 acknowledges receipt of the message to MS 60.
7. SMSC 44 forwards the short message to Gateway MSC 71. Gateway MSC 71 must determine where to route the message. To do this, Gateway MSC 71 must query HLR 72, which may really be M911 Network Element 46.
8. M911 Network Element 46 receives the Send Routing Information (SRI)-for-SMS message and must provide the address of the network element to which the message must be routed. Since the MSISDN parameter is set to 91911, M911 Network Element 46 knows the short message must get routed back to itself, so it can obtain the originating MS's MSISDN.
9. M911 Network Element 46 returns its own M911 Network Element Node Address in the Send Routing Information-for-Location services (SRI-for-LCS) response.
10. Gateway MSC 71 forwards the short message to M911 Network Element 46.
11. M911 Network Element 46 reads the MS 60 MSISDN and uses some technology to retrieve the MS 60 location. M911 Network Element 46 uses that location to query the Call Routing Data Base (CRDB 47; FIG. 6) for the RFAD 48 and PSAP 50 and delivers the short message to RFAD 48.
12. RFAD 48 delivers the message to the appropriate PSAP 50 and Data Terminal 52.
13. Data Terminal 52 acknowledges receipt of the short message to RFAD 48.
14. RFAD 48 acknowledges the short message to M911 Network Element 46.
15. M911 Network Element 46 acknowledges the receipt of the SMS to Gateway MSC 71.
16. Gateway MSC 71 acknowledges the receipt of the SMS to SMSC 44.

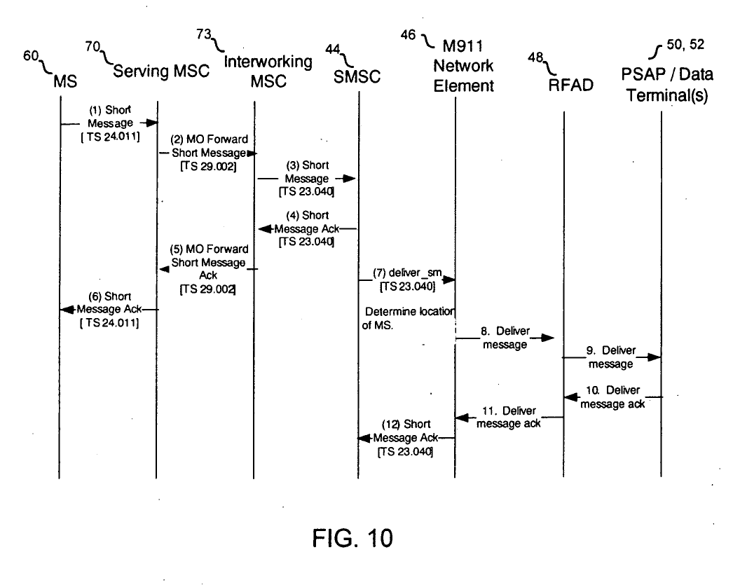

FIG. 10 is a schematic diagram illustrating call flow for a Messaging 911 (M911) communication in a GSM architecture using Short Message Peer-to-Peer (SMPP) Protocol. In FIG. 10, call flows are represented among (referring to components described in connection with FIG. 6) Mobile Station (MS) 60, Serving MSC 70, Interworking MSC 73, SMSC 44, M911 Network Element 46, RFAD 48, PSAP 50 and PSAP-associated Data Terminals 52.

Once the short message is delivered to SMSC 44, SMSC 44 directly sends the message to M911 Network Element 46 using SMPP (or some other protocol). M911 Network Element 46 determines the location of the originator (MS 60) and sends the short message to the appropriate RFAD 48:
1. The subscriber is in an emergency situation and sends a SMS with the short code “91911”. The message traverses through the air interface between MS 60 and communication tower 62 (FIG. 6; not shown in detail in FIG. 10; understood by those skilled in the art of wireless communications) and ends up at Serving MSC 70.
2. Serving MSC 70 converts the short message received into the MAP protocol format [TS 29.002]. This MAP-formatted message is then sent to Interworking MSC 73.
3. Interworking MSC 73 converts the message into a format SMSC 44 understands [TS 23.040] and sends the message for delivery or storage (or delivery and storage) to SMSC 44.
4. SMSC 44 sends an Acknowledgement “Ack” to Interworking MSC 73. The Ack means SMSC 44 has successfully received the message.
5. Interworking MSC 73 acknowledges receipt of the short message to Serving MSC 70.
6. Serving MSC 70 acknowledges receipt of the message to MS 60.
7. SMSC 44 directly connects to M911 Network Element 46 via SMPP or some other protocol. As a result, SMSC 44 delivers the short message to M911 Network Element 46.
8. M911 Network Element 46 reads the MS 60 MSISDN and uses some technology to retrieve the MS 60 location. M911 Network Element 46 uses that location to query CRDB 47 (FIG. 6) for the RFAD 48/PSAP 50 and delivers the short message to RFAD 48.
9. RFAD 48 delivers the short message to the appropriate PSAP data terminal(s) 52.
10. PSAP Data Terminal 52 acknowledges the short message to RFAD 48.
11. RFAD 48 acknowledges receipt of the short message to M911 Network Element 46.
12. M911 Network Element 46 acknowledges the receipt of the SMS to SMSC 44.

Other options exist, but would require modifications to MS 60 and possibly Serving MSC 70. One may store addresses for one or both of SMSC 44 and M911 Network Element 46 in MS 60. When MS 60 sends a M911 short message, the short message would be routed directly to the address stored in MS 60. Another option is to modify the code in Serving MSC 70 so Serving MSC 70 directly sends a short message to M911 Network Element 46 and not to SMSC 44.

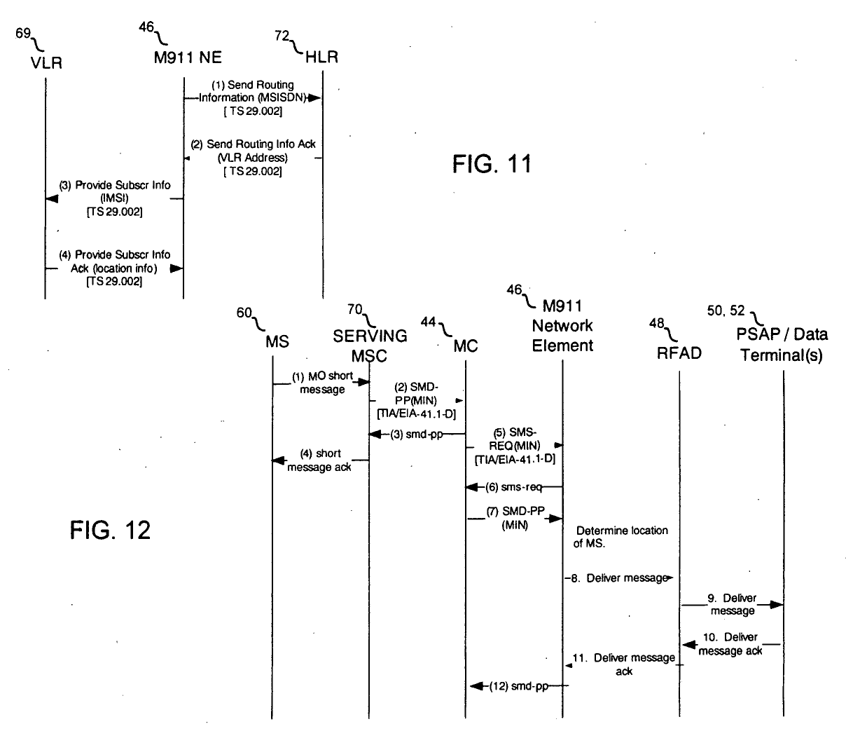

FIG. 11 is a schematic diagram illustrating call flow for determining the mobile's location information in a Messaging 911 (M911) system in a GSM architecture. In FIG. 11, call flows are represented among (referring to components described in connection with FIG. 6) Visitors' Location Register (VLR) 69, M911 Network Element 46 and Home Location Register (HLR) 72.

For the call flow described in connection with FIG. 9, a method is needed to determine the MS 60 location so M911 Network Element 46 can route the SMSIMMS to the correct PSAP 50. For any type of MS 60 such as, by way of example and not by way of limitation, GSM, CDMA, Personal Digital Assistant (PDA), smart phone, personal computer or another mobile station, VLR 69 can provide the location where a subscriber (MS 60) is situated by specifying the current GSM Global Cell ID.
1. M911 Network Element 46 acts as a Gateway MSC and asks HLR 72 for the MS 60 current VLR 69 by sending a Send Routing Information (SRI) message. The subscriber (MS 60) is identified by its respective MSISDN.
2. HLR 72 responds with the VLR Address in a Send Routing Information Acknowledgement (SRI-Ack) message.
3. M911 Network Element 46, now acting as a HLR, requests location information from the VLR identified in the SRI-Ack message. A Provide Subscriber Information (PSI) message is sent, identifying the subscriber (MS 60) using the International Mobile Subscriber Identity (IMSI).
4. The identified VLR returns the subscriber's (MS 60) location, specifying the GSM Global Cell ID, in a Provide Subscriber Information Acknowledgement (PSI-Ack) message.

In order for the PSAP 50 or Data Terminal 52 to deliver a message back to MS 60, the PSAP 50 or Data Terminal 52 forwards the message to RFAD 48. RFAD 48 in turn forwards the message to M911 Network Element 46. Acknowledgement messages (“Acks”) are returned back to RFAD 48 and PSAP 50 or Data Terminal 52. M911 Network Element 46 forwards the message to SMSC 44, preferably using SS7 or SMPP, depending upon the service provider. From there, the message is delivered as described in connection with FIG. 8.

FIG. 12 is a schematic diagram illustrating call flow for a Messaging 911 (M911) communication in a CDMA architecture. In FIG. 12, call flows are represented among (referring to components described in connection with FIG. 6) Mobile Station (MS) 60, Serving MSC 70, SMSC 44, M911 Network Element 46, RFAD 48, PSAP 50 and PSAP-associated Data Terminals 52.

In order to make M911 work with CDMA/IS-41 SMS, there are basically two architecture options and multiple call flow options. The architecture for CDMA, from a high level, looks very similar to the GSM architecture described in connection with FIG. 6. Some differences: (1) Instead of using MAP, CDMA uses the IS-41 protocol. Thus, wherever MAP is shown in FIG. 6, one must replace it with IS-41. (2) A short message service center (SMSC) may be referred to as a Message Center (MC). (3) HLR 72 takes a more active role in delivery of a short message. (4) Like with GSM, the connection between MC (SMSC) 44 and M911 Network Element 46 could be implemented using SS7, SMPP, or some other protocol. These various architecture options may impact the M911 call flow.

Although the architecture for SMS between GSM (MAP) and CDMA (IS-41) look similar at a high level, the messages flows differ. FIG. 12 illustrates a representative call flow for CDMA for M911 messaging:
1. The subscriber (MS 60) is in an emergency situation and sends a SMS with the short code “91911”. The message traverses through the air interface between MS 60 and communication tower 62 (FIG. 6; not shown in detail in FIG. 12; understood by those skilled in the art of wireless communications) and ends up at Serving MSC 70.
2. Serving MSC 70 converts the short message received into the IS-41 protocol format [TIA/EIA-41.1-D], using the Short Message Delivery Point-to-Point message. This IS-41 formatted message is then sent to Message Center 44.
3. Message Center 44 sends a return-result back to Serving MSC 70.
4. Serving MSC 70 sends an acknowledgement (“Ack”) message to MS 60 acknowledging the short message.
5. In the meantime, Message Center 44 requests forwarding of the short message, including the Mobile Identification Number (MIN) of MS 60, to M911 Network Element 46. The SMS-REQ message may be used.
6. M911 Network Element 46 acknowledges the SMS-REQ message.
7. Message Center 44 forwards the short message to M911 Network Element 46.
8. M911 Network Element 46 uses some technology to retrieve MS 60 location. M911 Network Element 46 uses that location to query the Call Routing Data Base (CRDB 47; FIG. 6) for the RFAD 48 and PSAP 50 and delivers the short message to RFAD 48.
9. RFAD 48 delivers the message to the appropriate PSAP 50 and associated Data Terminal(s) 52.
10. Data Terminal 52 acknowledges receipt of the short message to RFAD 48.
11. RFAD 48 acknowledges the short message to M911 Network Element 46.
12. M911 Network Element 46 acknowledges the receipt of the SMS to MC 6.

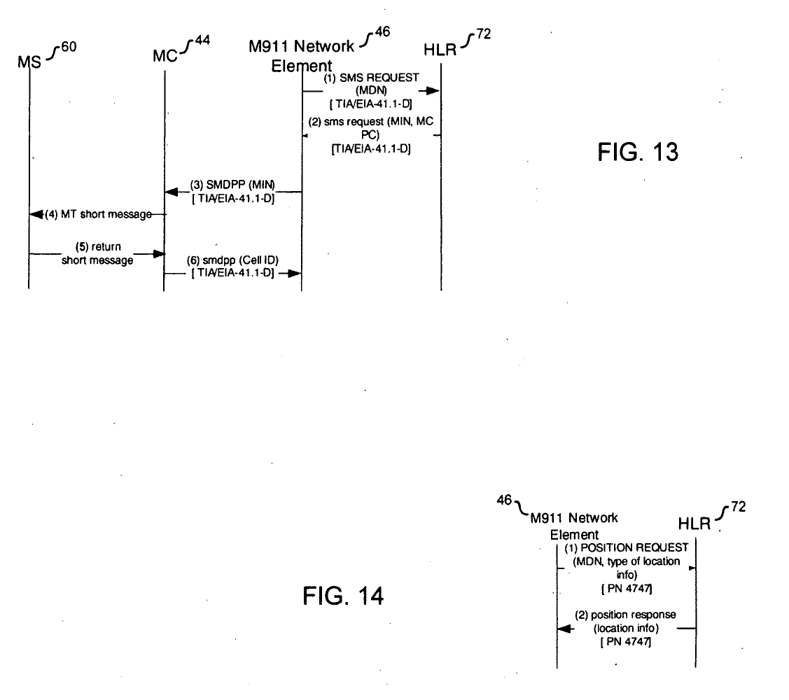

FIG. 13 is a schematic diagram illustrating call flow for a Messaging 911 (M911) communication in a CDMA architecture for effecting a momentary inquiry to retrieve serving cell identification. In FIG. 13, call flows are represented among (referring to components described in connection with FIG. 6) Mobile Station (MS) 60, Message Center (MC) 44, M911 Network Element 46 and Home Location Register (HLR) 72.

Some ideas for determining location of a Mobile Station operating in a system or network using CDMA/IS-41 may be based upon the message descriptions in the IS-41 specifications. One approach may involve “pinging” a Mobile Station using a short message in order to retrieve the Serving Cell Identification (ID):
1. M911 Network Element 46 acts as a MSC and asks HLR 72 for the MS 60 current MSC 70/VLR 69 and Mobile Identification Number (MIN) by sending a SMS Request message. The subscriber (MS 60) may be identified by its Mobile Directory Number (MDN).
2. HLR 72 responds with the point code or other identification of the MSC 70 NVLR 69 and MS 60 MIN in a SMS Request response.
3. M911 Network Element 46 forwards a short message to Serving MSC 70, specifying the MS 60 MIN. The purpose of this short message is to “ping” MS 60 for the Serving Cell ID.
4. Serving MSC 70 forwards the short message to MS 60.
5. MS 60 responds to the short message and includes “SMS_Bearer_Data”. According to the IS-41 specification, the “SMS_Bearer Data” parameter is defined by a “Teleservice Specification”.
6. Serving MSC 70 sends an acknowledgement message to M911 Network Element 46.

FIG. 14 is a schematic diagram illustrating call flow for a Messaging 911 (M911) communication for effecting an inquiry to retrieve location information. In FIG. 14, call flows are represented among (referring to components described in connection with FIG. 6) M911 Network Element 46 and Home Location Register (HLR) 72.

Alternatively, M911 Network Element 46 can request location information (Serving Cell ID or Location Area ID) from HLR 72:
1. M911 Network Element 46 acts as a MSC and asks HLR 72 for the MS 60 current location by sending a Position Request message. The subscriber (MS 60) is identified by its MDN. The type of location information being specified can include a Serving Cell ID or a Location Area ID.
2. HLR 72 initiates a location procedure within the network (not shown in detail in FIG. 14; see FIG. 6). HLR 72 then responds with the location information in a Position Request response message.

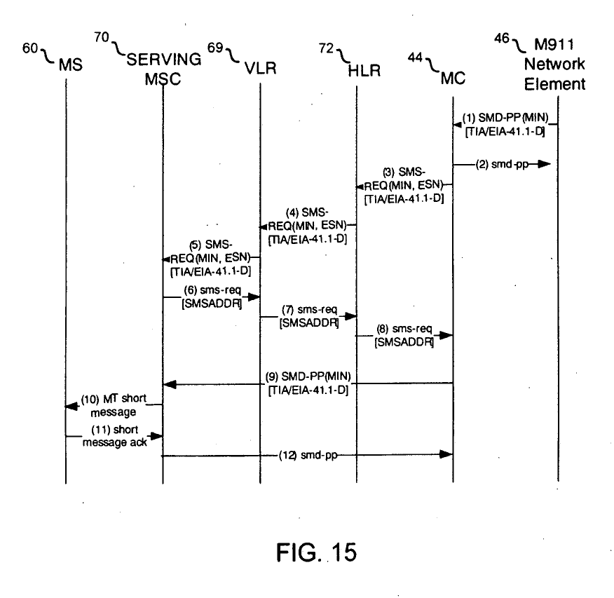

FIG. 15 is a schematic diagram illustrating call flow for M911 communications terminating with a mobile unit in a CDMA architecture. In FIG. 15, call flows are represented among (referring to components described in connection with FIG. 6) Mobile Station (MS) 60, Serving MSC 70, Visitors' Location Register (VLR) 69, Message Center (MC) 44, Home Location Register (HLR) 72 and M911 Network Element 46.

In order for PSAP 50/Data Terminal 52 to deliver a message back to MS 60, PSAP 50/Data Terminal 52 forwards the message to RFAD 48. RFAD 48 in turn forwards the message to M911 Network Element 46. Acknowledgement Messages (“Ack”) are returned to RFAD 48 and PSAP 50/Data Terminal 52. M911 Network Element 46 then forwards the message to Message Center 44, using SS7 or SMPP protocol, depending upon the service provider. From there, the message is delivered as illustrated in FIG. 15.
1. M911 Network Element 46 forwards the short message to Message Center 44. If SMPP or some other protocol is used between M911 Network Element 46 and Message Center 44, a different message and “Ack” may be sent.
2. Message Center 44 Acknowledges the short message using an “Ack” message.
3. Message Center 44 must learn the location of MS 60 so it can forward the short message to MS 60. In order to do this, Message Center 44 sends a short message request to HLR 72, SO Message Center 44 can learn the location of Serving MSC 70.
4. HLR 72 forwards the request to VLR 69.
5. VLR 69 forwards the request to Serving MSC 70.
6. Serving MSC 70 acknowledges the short message request using an “Ack” message to VLR 69.
7. VLR 69 acknowledges the SMS request to HLR 72.
8. HLR 72 sends an acknowledgement (“Ack”) message to Message Center 44.
9. Message Center 44 forwards the short message to Serving MSC 70 using a SMD-PP message.
10. Serving MSC 70 forwards the short message to MS 60.
11. MS 60 acknowledges receipt of the short message using an “Ack” message.
12. Serving MSC 70 indicates to Message Center 44 that the short message was delivered.

A GPS-capable MS 60 could insert its location information into the short message body and send the short message to M911 Network Element 46. M911 Network Element 46 could recognize location information in the body of the short message (a standard format could be defined) and route to the correct RFAD 48/PSAP 50 based upon the included location information. Software in MS 60 would format the short message in a standard format.

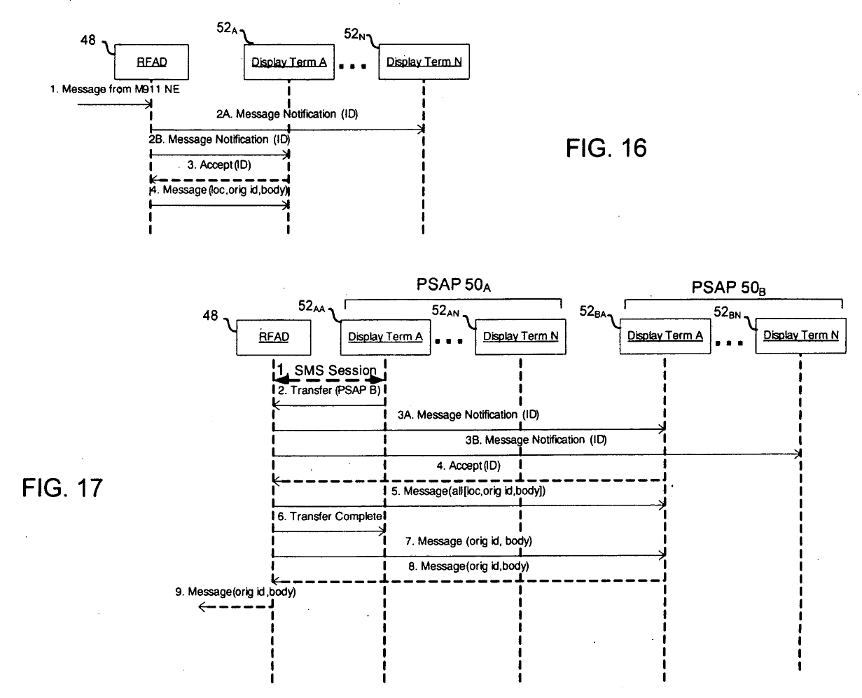

FIG. 16 is a schematic diagram illustrating call flow relating to selection of a particular call handler at a PSAP. In FIG. 16, call flows are represented among (referring to components described in connection with FIG. 6) Request for Assistance Distributor (RFAD) 48, a first Display Terminal 52_{A} and a second Display Terminal 52_{B}.

The call flows in FIG. 16 illustrate interaction between PSAP display terminals 52 and RFAD 48 during normal SMS call delivery. All display terminals 52_{A}, . . . , 52_{N} are notified and one of the request handlers at one of the display terminals 52_{N} accepts the request. All subsequent messages are forwarded to the accepting display terminal 52_{N}. The indicator “N” is employed to signify that there can be any number of Display Terminals in a PSAP 50 (not shown in FIG. 16; see FIG. 6). The inclusion of two Display Terminals 52_{A}, 52_{N} in FIG. 16 is illustrative only and does not constitute any limitation regarding the number of Display Terminals that may be included in a PSAP 50 employed in a system or network using the present invention. The call flow set out in FIG. 16 call flows related with GSM M911 calls described in connection with FIG. 9. That is, RFAD 48 has already obtained a message with location and chosen the appropriate PSAP 50. The flow illustrated in FIG. 16 sets out how a specific request handler (Display Terminal 52_{N}) at PSAP 50 is chosen.
1. RFAD 48 receives a message from M911 Network Element 46 (not shown in FIG. 16).
2. RFAD 48 sends a notification to all Display Terminals 52_{A}, . . . , 52_{N} at PSAP 50.
3. The request handler associated with Display Terminal 52_{A} accepts the request.
4. RFAD 48 forwards the message and any subsequent messages from the request initiator, to Display Terminal 52_{A}.

The call flow relating to a M911 call using MMS would be similar to FIG. 16 except that the multimedia URI is sent to the Data Display Terminal in step 4. Then the request handler uses the URI to retrieve the multimedia content from the Web Server.

FIG. 17 is a schematic diagram illustrating call flow relating to transferring an M911 call from a first PSAP to a second PSAP. In FIG. 17, call flows are represented among (referring to components described in connection with FIG. 6) Request for Assistance Distributor (RFAD) 48, Display Terminals 52_{AA}, . . . , 52_{AN} associated with a first PSAP 50A, and Display Terminals 52_{BA}, . . . , 52_{BN} associated with a second PSAP 50_{B}. The inclusion of two Display Terminals in each of two PSAPs in FIG. 17 is illustrative only and does not constitute any limitation regarding the number of Display Terminals or the number of PSAPs that may be included in a system or network using the present invention.

The call flows in FIG. 17 illustrate interaction between PSAP display terminals and RFAD 48 during message transfer. In FIG. 17 an extant session exists between the request initiator and the request handler at Display Terminal 52_{AA}. The request handler recognizes that PSAP 50_{B} should handle the extant Request for Assistance (RFA) and requests a blind transfer to PSAP 50_{B}. RFAD 48 notifies the Display Terminals 52_{BA}, . . . , 52_{BN} at PSAP 50_{B} and one request handler (associated with Display Terminal 52_{BA}) responds. All subsequent messages relating to the extant RFA are sent to PSAP 5O_{B}.
1. An existing session exists between the request initiator and Display Terminal 52_{AA} in PSAP 50_{A}.
2. The request handler at Display Terminal 52_{AA} in PSAP 50_{A} determines that a request handler from PSAP 50_{B} should manage the extant RFA and requests a transfer.
3. In steps 3A and 3B RFAD 48 notifies all Display Terminals 52_{BA}, . . . , 52_{BN} at PSAP 50_{B}.
4. The request handler at Display Terminal 52_{BA} in PSAP 50_{B} accepts the request.
5. RFAD 48 forwards all current messages that have been exchanged to Display Terminal 52_{BA} in PSAP 50_{B}.
6. RFAD 48 informs Display Terminal 52_{AA} in PSAP 50_{A} that the transfer is complete.
7. At some point the request initiator sends another SMS message and RFAD 48 recognizes that the message session has been transferred to Display Terminal 52_{BA} in PSAP 50_{B}.
8. The request handler at Display Terminal 52_{BA} in PSAP 50_{B} sends a message for the request initiator to RFAD 48.
9. RFAD 48 forwards the message to M911 Network Element 46 (not shown in FIG. 17) for further transfer to the request initiator.

At some point the request handler at Display Terminal 52_{BA} in PSAP 50_{B} determines that the session has ended and terminates the session.

The call flow relating to a M911 call using MMS would be similar to FIG. 17 except that the multimedia URI is sent to the Data Display Terminal in step 5. Then the request handler uses the URI to retrieve the multimedia content from the Web Server.

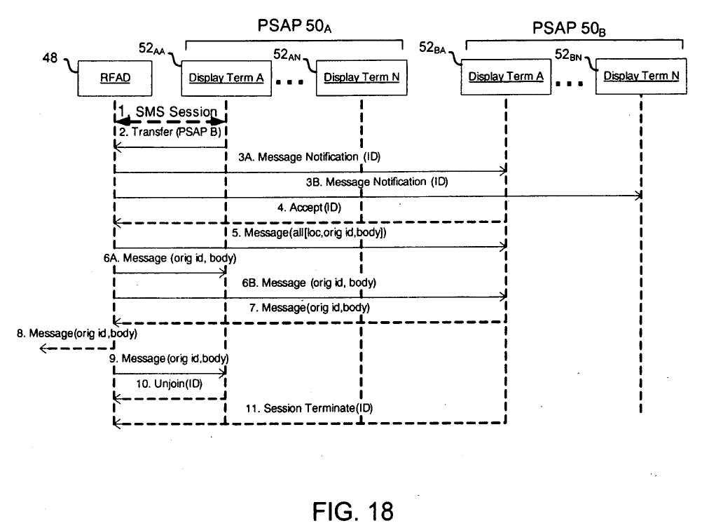

FIG. 18 is a schematic diagram illustrating call flow relating to effecting a consultive transfer of an M911 call from a first PSAP to a second PSAP. In FIG. 18, call flows are represented among (referring to components described in connection with FIG. 6) Request for Assistance Distributor (RFAD) 48, Display Terminals 52_{AA}, . . . , 52_{AN} associated with a first PSAP 50_{A,} and Display Terminals 52_{BA}, . . . 52_{BN} associated with a second PSAP 50_{B}.

The call flows in FIG. 18 illustrate interaction between PSAP Display Terminals and RFAD 48 during joining an existing session. In FIG. 18 an extant session exists between the request initiator and the request handler at Display Terminal 52_{AA}. The request handler recognizes that PSAP 50_{B} should handle the extant Request for Assistance (RFA) and requests a consultive transfer to PSAP 50_{B.} RFAD 48 notifies the Display Terminals 52_{BA}, . . . , 52_{BN} at PSAP 50_{B} and one request handler (associated with Display Terminal 52_{BA}) responds. All messages are sent to both Display Terminal 52_{AA} and Display Terminal 52_{BA} until the request handler at Display Terminal 52_{AA} “disjoins” the session.
1. An extant session exists between the request initiator and Display Terminal 52_{AA} in PSAP 50_{A}.
2. The request handler at Display Terminal 52_{AA} in PSAP 50_{A} determines that a request handler from PSAP 50_{B} should manage the RFA and requests a transfer.
3. RFAD 48 notifies all Display Terminals 52_{BA}, . . . , 52_{BN} at PSAP 50_{B}.
4. The request handler at Display Terminal 52_{BA} in PSAP 50_{B} accepts the request.
5. RFAD 48 forwards all current messages that have been exchanged to at Display Terminal 52_{BA} in PSAP 50_{B}.
6. At some point the request initiator sends another SMS message and RFAD 48 recognizes that two request handlers are involved in the exchange. RFAD 48 sends the message to Display Terminal 52_{AA} in PSAP 50_{A} and Display Terminal 52_{BA} in PSAP 5O_{B}.
7. The request handler at Display Terminal 52_{BA} in PSAP 50_{B} sends a message to the request initiator.
8. RFAD 48 forwards the message to M911 Network Element 46 (not shown in FIG. 18; see FIG. 6).
9. In addition RFAD 48 forwards the message to Display Terminal 52_{AA} in PSAP 5O_{A}.
10. At some point the request handler at Display Terminal 52_{AA} in PSAP 50_{A} disengages with the session. The request initiator and Display Terminal 52_{BA} in PSAP 50_{B} are still in the session
11. At some point the request handler at Display Terminal 52_{BA} in PSAP 50_{B} determines that the session has ended and terminates it.

The call flow relating to a M911 call using MMS would be similar to FIG. 18 except that the multimedia URI is sent to the Data Display Terminal in step 5. Then the request handler uses the URI to retrieve the multimedia content from the Web Server.

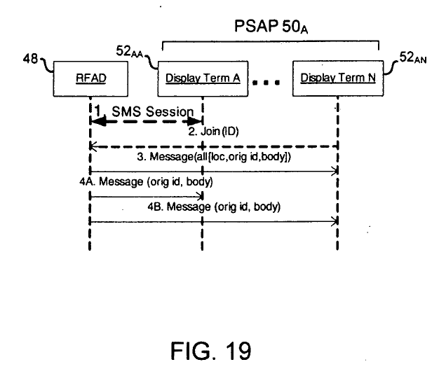

FIG. 19 is a schematic diagram illustrating call flow relating to effecting a joining in an ongoing M911 call session by a PSAP operator. In FIG. 19, call flows are represented among (referring to components described in connection with FIG. 6) Request for Assistance Distributor (RFAD) 48 and Display Terminals 52_{AA}, . . . , 52_{AN} associated with a PSAP 5O_{A}.

In FIG. 19 an extant session exists between the request initiator and the request handler at Display Terminal 52_{AA} in PSAP 50_{A}. The request handler at Display Terminal 52_{AN} in PSAP 50_{A} wants to join the session. Through some unspecified process the request handler at Display Terminal 52_{AN} learns the session ID and joins the session.
1. An extant current session is active between the request initiator and Display Terminal 52_{AA} in PSAP 5O_{A}.
2. The request handler at Display Terminal 52_{AN} in PSAP 50_{A} learns the session ID and issues a join action.
3. All previous messages are forwarded to Display Terminal 52_{AN} in PSAP 5O_{A}.
4. All new messages are forwarded to both request handlers at Display Terminals 52_{AA}, 52_{AN}.

The call flow relating to a M911 call using MMS would be similar to FIG. 19 except that the multimedia URI is sent to the Data Display Terminal in step 3. Then the request handler uses the URI to retrieve the multimedia content from the Web Server.

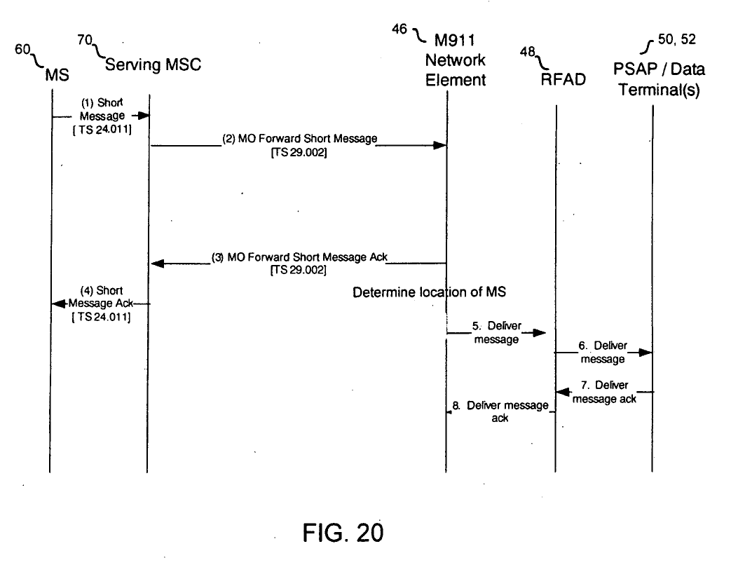

FIG. 20 is a schematic diagram illustrating call flow for a Messaging 911 (M911) communication in a GSM architecture directly from a Serving MSC to a M911 Network Element. In FIG. 20, call flows are represented among (referring to components described in connection with FIG. 6) Mobile Station (MS) 60, Serving MSC 70, M911 Network Element 46, RFAD 48, PSAP 50 and PSAP-associated Data Terminals 52.

Mobile Station (MS) 60 sends an emergency SM to “91911”. The SM eventually reaches PSAP-associated Data Terminals 52. Unlike in FIG. 10, Inter-working MSC 73 and legacy SMSC 44 are not involved. Serving MSC 70 forwards the SM directly to M911 Network Element 46 through an SS7/STP network (or uses another other protocol). This direct link between Serving MSC 70 and M911 Network Element 46 will significantly reduce the SMS delay issue caused by “store-and-forward” techniques used when other network elements may be involved in the call. M911 Network Element 46 determines the location of the originator (MS 60) and sends the short message to the appropriate RFAD 48:
1. The subscriber is in an emergency situation and sends a SMS with the short code “91911”. The message traverses through the air interface between MS 60 and communication tower 62 (FIG. 6; not shown in detail in FIG. 20; understood by those skilled in the art of wireless communications) and ends up at Serving MSC 70.
2. For a “91911” emergency SM, Serving MSC 70 converts the short message received into the MAP protocol format [TS 29.002]. This MAP-formatted message is then sent to M911 Network Element 46. (NOTE: For other non-emergency SMs, Serving MSC 70 sends the SM to Inter-working MSC 73 and thence to SMSC 44 as described in connection with FIG. 10).
3. M911 Network Element 46 saves the MS 60 MSISDN and Serving MSC 70 relationship and also acknowledges receipt of the SM to Serving MSC 70.
4. Serving MSC 70 acknowledges receipt of the SM to MS 60.
5. M911 Network Element 46 reads the MS 60 MSISDN and uses a location technology to retrieve the MS 60 location. M911 Network Element 46 uses that location to query CRDB 47 (FIG. 6) for the RFAD 48/PSAP 50 and delivers the short message to RFAD 48.
6. RFAD 48 delivers the short message to the appropriate PSAP data terminal(s) 52.
7. PSAP Data Terminal 52 acknowledges the short message to RFAD 48.
8. RFAD 48 acknowledges receipt of the short message to M911 Network Element 46.

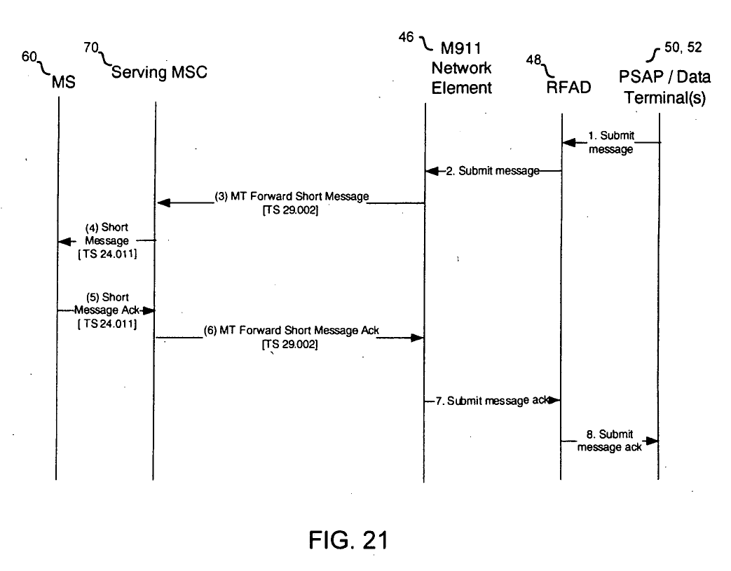

FIG. 21 is a schematic diagram illustrating call flow for an outgoing Emergency Short Message from a PSAP to a Mobile Station. In FIG. 21, call flows are represented among (referring to components described in connection with FIG. 6) PSAP-associated Data Terminals 52, PSAP 50, RFAD 48, M911 Network Element 46, Serving MSC 70 and Mobile Station (MS) 60.

PSAP-associated Data Terminal 52 sends a reply SM intended for delivery to Mobile Station (MS) 60 in response to an earlier received emergency SM. Since the relationship between Serving MSC 70 and MSISDN of Mobile Station (MS) 60 was cached in step 3 in FIG. 20 (SM origination), M911 Network Element 46 can send a reply SM directly to Serving MSC 70 through an SS7/STP network (or use another protocol). There is therefore also no need to query an HLR (e.g., HLR 72; FIG. 6) to ascertain an address for Serving MSC 70 and no need to involve Inter-working MSC 73 and SMSC 44. Not involving those elements (HLR 72, Inter-working MSC 73 or SMSC 44) will significantly reduce the SMS delay issue caused by “store-and-forward” techniques used when those elements may be involved in the call. This can also avoid the situation when the HLR cannot be successfully queried to find the Serving MSC address.
1. PSAP Data Terminal 52 sends (replies back) a SM to RFAD 48.
2. RFAD 48 forwards the SM to M911 Network Element 46.
3. M911 Network Element 46 forwards the SM directly to Serving MSC 70 without querying an HLR for the address of Serving MSC 70, since the relationship of Serving MSC 70 and MS 60 was previously cached (e.g., as described in connection with step 3 of FIG. 20).
4. Serving MSC 70 forwards the SM to MS 60.
5. MS 60 sends an acknowledge back to Serving MSC 70.
6. Serving MSC 70 sends an acknowledge back to M911 Network Element 46.
7. M911 Network Element 46 sends an acknowledge back to RFAD 48.
8. RFAD 48 sends an acknowledge back to PSAP Data Terminal 52.

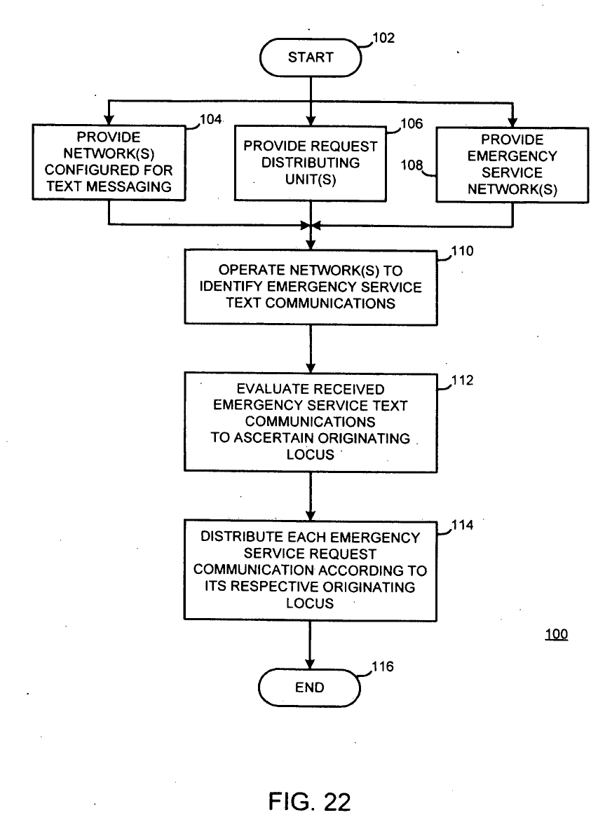

FIG. 22 is a flow chart illustrating the method of the present invention. In FIG. 22, a method 100 for effecting wireless emergency service communication using text messaging begins at a START locus 102. Method 100 continues with, in no particular order: (1) providing at least one network configured for treating received the text messaging, as indicated by a block 104; (2) providing at least one request distributing unit coupled with the at least one network for receiving the emergency service text communications, as indicated by a block 106; and (3) providing at least one emergency service network coupled with the at least one request distributing unit, as indicated by a block 108.

Method 100 continues with operating each respective network of the at least one network to effect identifying emergency service text communications among the received text messaging, as indicated by a block 110.

Method 100 continues with evaluating each respective received emergency service text communication by at least one of the at least one network and the at least one request distributing unit to effect ascertaining a respective communication originating locus relating to each the respective received emergency service test communication, as indicated by a block 112.

Method 100 continues with distributing each respective received emergency service text communication within the at least one emergency service network by at least one respective request distributing unit of the at least one request distributing unit according to the respective communication originating locus, as indicated by a block 114.

Method 100 terminates at an END locus 116.

It is to be understood that, while the detailed drawings and specific examples given describe embodiments of the invention, they are for the purpose of illustration only, that the system and method of the invention are not limited to the precise details and conditions disclosed and that various changes may be made therein without departing from the spirit of the invention which is defined by the following claims:

1. A system for effecting wireless emergency service communication using text messaging; the system comprising:
(a) at least one network configured for treating received said text messaging; each respective network of said at least one network identifying emergency service text communications among said received text messaging;
(b) at least one request distributing unit coupled with said at least one network for receiving said emergency service text communications; and
(c) at least one emergency service network coupled with said at least one request distributing unit;
each respective said received emergency service text communication being evaluated by at least one of said at least one network and said at least one request distributing unit to effect ascertaining a respective communication originating locus relating to each said respective received emergency service text communication; each respective said received emergency service text communication being distributed within said at least one emergency service network by at least one respective request distributing unit of said at least one request distributing unit according to said respective communication originating locus.

2. A system for effecting wireless emergency service communication using text messaging as recited in claim 1 wherein said received emergency service text communication is received from an originating unit, wherein said received emergency service text communication is routed to a receiving emergency service answering unit within said at least one emergency service network and wherein said at least one network, said at least one request distributing unit and said at least one emergency service network cooperate to establish two-way communications between said originating unit and said receiving emergency service answering unit.

3. A system for effecting wireless emergency service communication using text messaging as recited in claim 1 wherein said at least one emergency service text communication originates from a wireless communication unit using at least one text messaging format among a Short Message Service format, a Multimedia Messaging Service format and an Unstructured Supplementary Service Data format.

4. A system for effecting wireless emergency service communication using text messaging as recited in claim 1 wherein said at least one network is configured for treating at least one communication protocol of a time division multiple access protocol and a code division multiple access protocol.

5. A system for effecting wireless emergency service communication using text messaging as recited in claim 1 wherein said emergency service text communications are presented to a particular said request distributing unit of said at least one request distributing unit after said ascertaining said respective communication originating locus.

6. A system for effecting wireless emergency service communication using text messaging as recited in claim 2 wherein said emergency service text communications are presented to a particular said request distributing unit of said at least one request distributing unit after said ascertaining said respective communication originating locus.

7. A system for effecting wireless emergency service communication using text messaging as recited in claim 6 wherein said at least one network is configured for treating at least one communication protocol of a time division multiple access protocol and a code division multiple access protocol.

8. A system for effecting wireless emergency service communication using text messaging as recited in claim 7 wherein said at least one emergency service text communication originates from a wireless communication unit using at least one text messaging format among a Short Message Service format, a Multimedia Messaging Service format and an Unstructured Supplementary Service Data format.

9. A system for treating a text message emergency request; said text messages originating from an originating wireless communicating unit operating in a serving network; the system comprising:
(a) an emergency request distributing unit coupled with said serving network; and
(b) an emergency service network coupled with said emergency request distributing unit;
said emergency request distributing unit cooperating with said serving network to receive said text message emergency request and identify an originating locus relating to said received text message emergency request; said emergency request distributing unit presenting said received text message emergency request within said emergency service network according to said originating locus.

10. A system for treating a text message emergency request as recited in claim 9 wherein said text message emergency request is routed to a receiving emergency service answering unit within said emergency service network, and wherein said emergency service network, said emergency request distributing unit and said serving network cooperate to establish two-way communications between said originating wireless communicating unit and said receiving emergency service answering unit.

11. A system for treating a text message emergency request as recited in claim 9 wherein said originating wireless communicating unit uses at least one text messaging format among a Short Message Service format, a Multimedia Messaging Service format and an Unstructured Supplementary Service Data format.

12. A system for treating a text message emergency request as recited in claim 9 wherein said serving network is configured for treating at least one communication protocol of a time division multiple access protocol and a code division multiple access protocol.

13. A system for treating a text message emergency request as recited in claim 9 wherein said text message emergency request is routed to a receiving emergency service answering unit within said emergency service network substantially immediately after identifying said originating locus.

14. A system for treating a text message emergency request as recited in claim 10 wherein said text message emergency request is routed to said receiving emergency service answering unit substantially immediately after identifying said originating locus.

15. A system for treating a text message emergency request as recited in claim 14 wherein said serving network is configured for treating at least one communication protocol of a time division multiple access protocol and a code division multiple access protocol.

16. A system for treating a text message emergency request as recited in claim 15 wherein said originating wireless communicating unit uses at least one text messaging format among a Short Message Service format, a Multimedia Messaging Service format and an Unstructured Supplementary Service Data format.

17. A method for effecting wireless emergency service communication using text messaging; the method comprising:
(a) in no particular order:
(1) providing at least one network configured for treating received said text messaging;
(2) providing at least one request distributing unit coupled with said at least one network for receiving said emergency service text communications; and
(3) providing at least one emergency service network coupled with said at least one request distributing unit;
(b) operating each respective network of said at least one network to effect identifying emergency service text communications among said received text messaging;
(c) evaluating each respective said received emergency service text communication by at least one of said at least one network and said at least one request distributing unit to effect ascertaining a respective communication originating locus relating to each said respective received emergency service test communication; and
(d) distributing each respective said received emergency service text communication within said at least one emergency service network by at least one respective request distributing unit of said at least one request distributing unit according to said respective communication originating locus.

18. A method for effecting wireless emergency service communication using text messaging as recited in claim 17 wherein said received emergency service text communication is received from an originating unit, wherein said received emergency service text communication is routed to a receiving emergency service answering unit within said at least one emergency service network and wherein said at least one network, said at least one request distributing unit and said at least one emergency service network cooperate to establish two-way communications between said originating unit and said receiving emergency service answering unit.

19. A method for effecting wireless emergency service communication using text messaging as recited in claim 18 wherein said at least one emergency service text communication originates from a wireless communication unit using at least one text messaging format among a Short Message Service format, a Multimedia Messaging Service format and an Unstructured Supplementary Service Data format.

20. A method for effecting wireless emergency service communication using text messaging as recited in claim 19 wherein said at least one network is configured for treating at least one communication protocol of a time division multiple access protocol and a code division multiple access protocol.

21. A method of providing text message E911 emergency services, comprising:
receiving a text message E911 emergency data request from an end user requiring emergency assistance;
associating a geographic location of a sender of said text message E911 emergency data request, with said text message E911 data request; and
staging said geographic location of said sender of said text message E911 emergency data request in a database for access by emergency services.

22. The method of providing text message E911 emergency services according to claim 21, wherein said location comprises:
a geographic location.

23. The method of providing text message E911 emergency services according to claim 21, wherein said location comprises:
a civic location.

24. The method of providing text message E911 emergency services according to claim 21, wherein said location comprises at least one of:
a street address; and
a placename.

25. The method of providing text message E911 emergency services according to claim 24, wherein said location comprises:
a MSC/Serving Cell ID.

26. The method of providing text message E911 emergency services according to claim 21, wherein said location comprises:
a location reference.

27. The method of providing text message E911 emergency services according to claim 26, wherein said location comprises at least one of:
a URI; and
a URL.

28. The method of providing text message E911 emergency services according to claim 21, wherein:
said emergency services is a public safety access point (PSAP).

29. The method of providing text message E911 emergency services according to claim 28, further comprising:
providing a notification to said public safety access point of receipt of said text message E911 emergency data request.

30. The method of providing text message E911 emergency services according to claim 29, wherein:
said notification is an audible notification.

31. The method of providing text message E911 emergency services according to claim 21, further comprising:
staging said text message in a database for access by a public safety access point (PSAP).

32. The method of providing text message E911 emergency services according to claim 21, wherein:
said text message is a short messaging system (SMS) message.

33. The method of providing text message E911 emergency services according to claim 21, wherein:
said text message is an e-mail.

34. The method of providing text message E911 emergency services according to claim 21, wherein:
said text message is an Internet chat message (XMPP).

35. The method of providing text message E911 emergency services according to claim 21, wherein:
said text message is an XML post message (HTUP).

36. The method of providing text message E911 emergency services according to claim 21, wherein:
said text message is a multimedia message service (MMS) image.

37. Apparatus for providing text message E911 emergency services, comprising:
means for receiving a text message E911 emergency data request form an end user requiring emergency assistance;
means for associating a geographic location of a sender of said text message E911 emergency data request, with said text message E911 data request; and
means for staging said geographic location of said sender of said text message E911 emergency data request in a database for access by emergency services.

38. The apparatus for providing text message E911 emergency services according to claim 37, wherein said location comprises:
a geographic location.

39. The apparatus for providing text message E911 emergency services according to claim 37, wherein said location comprises:
a civic location.

40. The apparatus for providing text message E911 emergency services according to claim 37, wherein said location comprises at least one of:
a street address; and
a placename.

41. The apparatus for providing text message E911 emergency services according to claim 40, wherein said location comprises:
a MSC/Serving Cell ID.

42. The apparatus for providing text message E911 emergency services according to claim 37, wherein said location comprises:
a location reference.

43. The apparatus for providing text message E911 emergency services according to claim 42, wherein said location comprises at least one of:
a URI; and
a URL.

44. The apparatus for providing text message E911 emergency services according to claim 37, wherein:
said emergency services is a public safety access point (PSAP).

45. The apparatus for providing text message E911 emergency services according to claim 37, further comprising:
means for providing a notification to said public safety access point of receipt of said text message E911 emergency data request.

46. The apparatus for providing text message E911 emergency services according to claim 37, wherein:
said notification is an audible notification.

47. The apparatus for providing text message E911 emergency services according to claim 37, further comprising:
Means for staging said text message in a database for access by a public safety access point (PSAP).

48. The apparatus for providing text message E911 emergency services according to claim 37, further comprising:

49. The apparatus for providing text message E911 emergency services according to claim 37, wherein:
said text message is an e-mail.
